(19) United States
(12) Patent Application Publication
(10) Pub. No.: US 2004/0264201 A1
(43) Pub. Date: Dec. 30, 2004

(54) Chromatic effect using light sources and condensing lenses

(75) Inventor: Jan A. Wisler, Anderson, IN (US)

Correspondence Address: Jay G. Taylor, ICE MILLER, One American Square, Box 82001, Indianapolis, IN, 46282-0002, US

(73) Assignee: Guide Corporation, A Delaware Corporation, Pendleton, IN

(21) Appl. No.: 10/610,443

(22) Filed: Jun. 30, 2003

(51) Int. Cl. F21V 13/12; F21V 7/04

(52) U.S. Cl. 362/343; 362/308; 362/510

(57) ABSTRACT

A peripheral beam lamp is described for use with automobile lamps. A light source is positioned within a housing, and the inner surface of the housing has a non-reflective surface and a partially reflective section. Light emitted from the light source may either strike the non-reflective surface or the partially reflective section, or may not strike any part of the inner surface of the housing before being emitted from the lamp assembly. Light striking the non-reflective surface is absorbed, and light striking the partially reflective section is partially reflected, depending on the color of the light and the color of the partially reflective section. Light emitted from the lamp assembly without striking the inner surface of the housing forms a main beam, and the light striking the partially reflective section imparts a color to the lens and lamp assembly, rendering a stylized appearance.

### BACKGROUND

The modern automobile consumer is often intrigued and impressed by various functional features and styling designs that have little to do with automobile performance, and more to do with the overall look and style of the automobile. Extra features added to automobiles may incline a consumer to purchase one automobile over another. To this end, automobile manufacturers consider extra automobile features to be advantageous, and headlamp manufacturers continually try to improve the stylization and functional features offered with headlamps and tail lamps. Accordingly, it is advantageous to provide unique and impressive features for headlamps, which may attract the interest of consumers and draw attention to the stylization of the vehicle.

Accordingly, it would be advantageous to provide an automobile headlamp or tail lamp having the ability to project light of one overall color in a main beam, but provide for the inside of the housing and the lens to appear to be a second color. By projecting light of a second color about the main beam, a dichroic effect may be created about the headlamp or tail lamp, where the light emitted from the lamp assembly may be of one overall color, but the lamp assembly appears to be a second, distinct, color when viewed from the periphery. Installed as a headlamp, the invention could project a main beam of light satisfying current lighting requirements for color and intensity, but also a peripheral beam, visible only from the sides of the automobile, with alternate lighting characteristics. A new lighting stylization could thus be brought to the automobile without affecting the standard function of the automobile lamp. The new stylization may increase consumer attention to a particular automobile over another automobile which did not have the stylization.

### SUMMARY

A peripheral beam lamp comprises a housing, a light source positioned within the housing, and a condensing lens positioned in front of the housing. The housing is substantially conical, and contains an inner surface, a first opening, and a second opening, with the first opening and the second opening positioned opposite one another along the long axis of the conical housing. A partially reflective section and a non-reflective matte section are positioned within the housing, on the inner surface. Light rays which strike the non-reflective matte section are substantially absorbed, and light rays which strike the partially reflective section are selectively reflected, depending on the color of the light rays and the color of the partially reflective section. The surface of the partially reflective section contains irregular projections or knurls, to scatter the reflected light rays.

When the light source is illuminated, the light rays from the light source which do not strike the inner surface of the housing are angled by the condensing lens and emitted from the lamp assembly. The light rays which strike the non-reflective matte section are absorbed. The light rays which strike the partially reflective section are selectively reflected, depending on the color of the light rays and the color of the partially reflective surface. The light rays reflected are scattered by the knurls of the partially reflective surface, and so are reflected in non-uniform directions. The reflected light rays impart the color of the partially reflective section to the condensing lens and the lamp assembly, while the main beam of light rays, comprised of those light rays not striking the inner surface of the housing, remain the overall color of the light emitted from the light source. Thus, a stylized feature is imparted to the lamp assembly, without significantly altering the intended purpose.

These and other advantages and features of the present invention shall hereinafter appear, and for the purposes of illustration, but not limitation, exemplary embodiments of the present invention shall hereinafter be described.

### BRIEF DESCRIPTION OF THE DRAWINGS

FIG. 1 is a side view of a peripheral beam lamp;

FIG. 2 is a side cut-away view of a portion of the peripheral beam lamp of FIG. 1, showing exemplary light beams emitted from the lamp assembly;

FIG. 3 is a side cut-away view of the peripheral beam lamp of FIG. 1, showing exemplary light beams inside the housing; and

FIG. 4 is a cross sectional view of the exemplary light beams taken along line A-A of FIG. 2.

### DETAILED DESCRIPTION

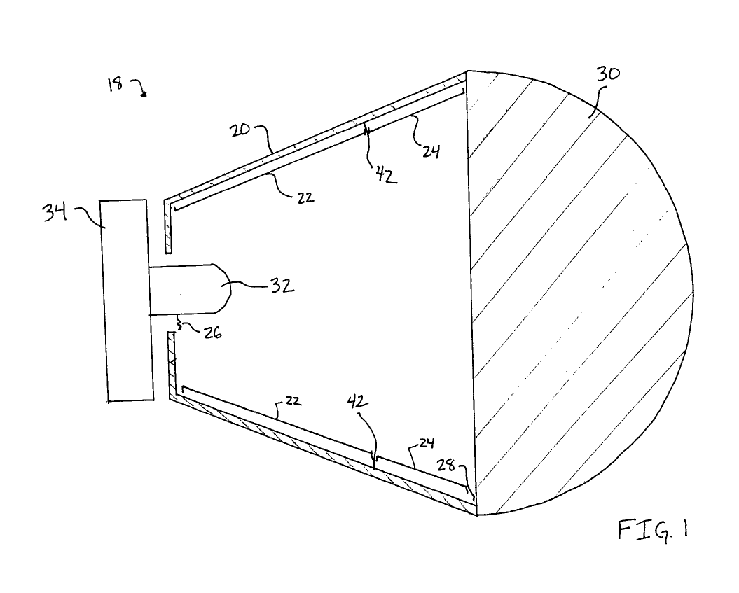

One embodiment of a peripheral beam lamp is provided as shown in FIG. 1, and is generally indicated as numeral 18. With reference to FIG. 1, the peripheral beam lamp 18 comprises a housing 20, a light source 32 attached to a light source electrical system 34, and a condensing lens 30. The housing 20 has an interior sidewall 42 divided into a non-reflective matte section 22 and a partially reflective section 24.

The housing 20 has a substantially conical or parabolic shape, or may optionally be formed according to any shape known in the art for forming a housing. The housing 20 includes a sidewall 42, a first opening 26, and a second opening 28, with the first opening 26 and the second opening 28 apparent opposite each other along the cylindrical axis of the housing 20. The non-reflective matte section 22 of the sidewall 42 and the partially reflective section 24 are apparent along the inner surface of the housing 20, and are adjacent to each other. The non-reflective matte section 22 extends around the sidewall 42 of the housing 20, located near the first opening 26, and adjacent to the light source 32. The matte section 22 is substantially non-reflective, and absorbs light rays which are emitted from the light source 32. The matte section 22 may be formed from any material which is substantially non-reflective. The partially reflective section 24 selectively reflects light of a specific wavelength or range of wavelengths, and absorbs light of outside of the specific wavelength or wavelengths. The partially reflective section 24 may optionally also be located on the sidewalls 42. The partially reflective section 24 may be any color. One possible embodiment of the present invention comprises a blue partially reflective section 24 that reflects light having a blue tint.

Both the non-reflective matte section 22 and the partially reflective section 24 may be deposited on the inner surface of the housing 20. For example, the matte section 22 and the partially reflective section 24 may be painted on the inner surface of the housing 20, or may be deposited on the inner surface of the housing 20 by a vapor deposition process, or may be deposited by any other means, as known in the art. Alternately, the housing 20 may be formed using materials which create a matte section 22 or a partially reflective section 24. Also, the shape and positioning of the matte section 22 and the partially reflecting section 24 is not intended to be limited to the embodiment as shown in FIG. 1. The partially reflecting section 24 may extend over any portion of the sidewall 42, including over the entire sidewall 42. If the partially reflecting surface 24 extends over all of the sidewall 42, the matte section 22 is omitted.

The light source 32 is attached to the light source electrical system 34. The light source 32 is positioned through the first housing opening 26, so that the light source 32 is positioned within the housing 20. The light source 32 may be a halogen lamp, a gas-discharge lamp, a single light emitting diode or an array of light emitting diodes, or any other lamp as known in the art. The light source 32 may emit light of any wavelength or range of wavelengths, as may be required by lighting guidelines or to fulfill aesthetic functionality. If more than one light source is used, as in an array of light emitting diodes, each light source may emit a distinct wavelength or range of wavelengths, as desired.

The light source electrical system 34 receives electricity from the automobile's electrical system (not shown), and is controlled by a human operated switch and/or by a microprocessor in the automobile, or by any other method for operating automobile lamps. When the light source is a light emitting diode, the light source electrical system 34 changes the properties of the electricity from the automobile, such as wattage or amperage, into a form which may be used to energize the light source 32.

The condensing lens 30 is supported by the housing 20, positioned over the second housing opening 28 and sealed to the housing 20, thereby enclosing the interior of the housing 20. The seal may be accomplished in any of a number of ways well known in the art. The lens 30 is a converging lens manufactured from a transparent or semi-transparent material. The converging lens 30 serves to focus or angle emitted light rays and has properties and characteristics that are well known in the art.

Operation of the disclosed embodiment of a peripheral beam lamp 18 is now described with reference to FIGS. 1-4.

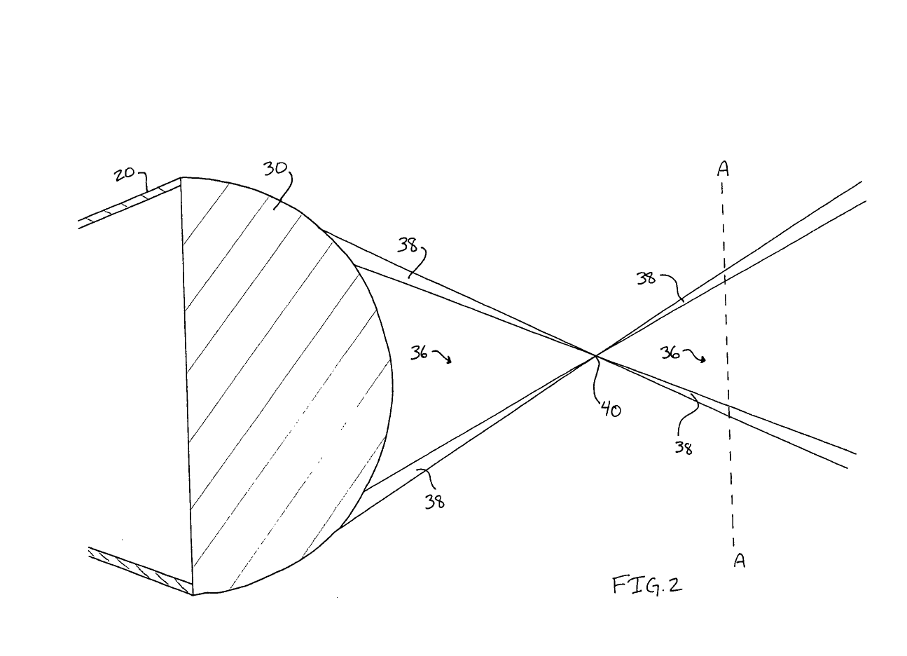

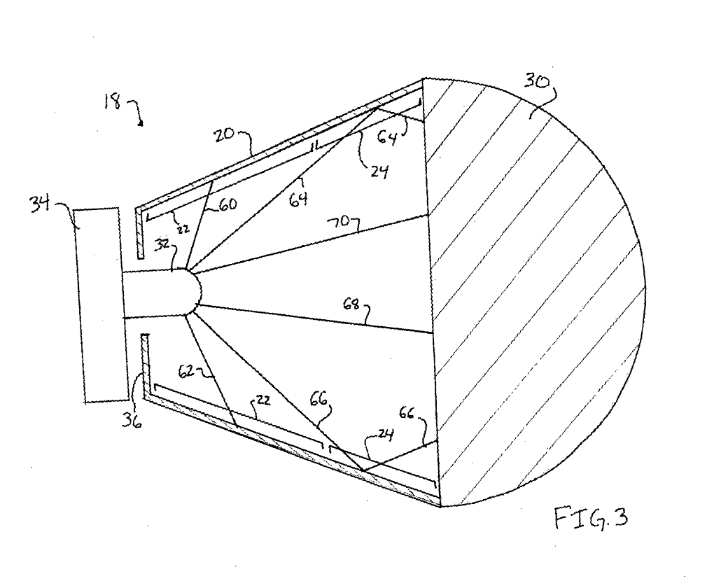

The light source 32, when energized by the light source electrical system, produces light rays which emit from the light source 32 and into the housing 20. With reference to FIG. 3, six exemplary light rays are shown emitting from the light source 32 and into the housing 20. The light rays 60 and 62 travel from the light source 32 and strike the inner surface of the housing 20 which is formed from or is coated with the non-reflective matte section 22. The light rays 60 and 62 are absorbed by the non-reflective matte section 22, and thus are not reflected by the inner surface of the housing 20. The light rays 60 and 62, if allowed to reflect on the surface of the housing 20 and emit outside of the housing 20, may emit from the housing 20 in such a manner as to cause undesirable glare light. The light rays 64 and 66 are emitted from the light source 32, and strike the partially reflective section 24 on the inner surface of the housing 20. Select wavelengths of light are reflected by the partially reflective section 24, and other wavelengths are absorbed by the partially reflective section 24. The reflected and absorbed wavelengths of light are determined by the color of the partially reflective section 24. As described above, the partially reflective section 24 may reflect light of any color, depending on the properties of the surface. Additionally, the partially reflective section 24 is knurled, having a plurality of small projections from the surface, so that the light rays which strike the partially reflective section 24 are reflected in non-uniform directions. The scattering of the light rays serves to reduce the amount of glare light, by diffusing the light emitted in the peripheral beam. The light rays 64 and 66 which are reflected from the partially reflective section 24 exit from the housing 20 and are focused to the focal point 40 (see FIG. 2) by the condensing lens 30. The light rays 68 and 70 emit from the light source 32 into the housing 20, but do not strike the inner surface of the housing 20. The rays 68 and 70 exit the housing 20 and are focused to the focal point 40 by the condensing lens 30.

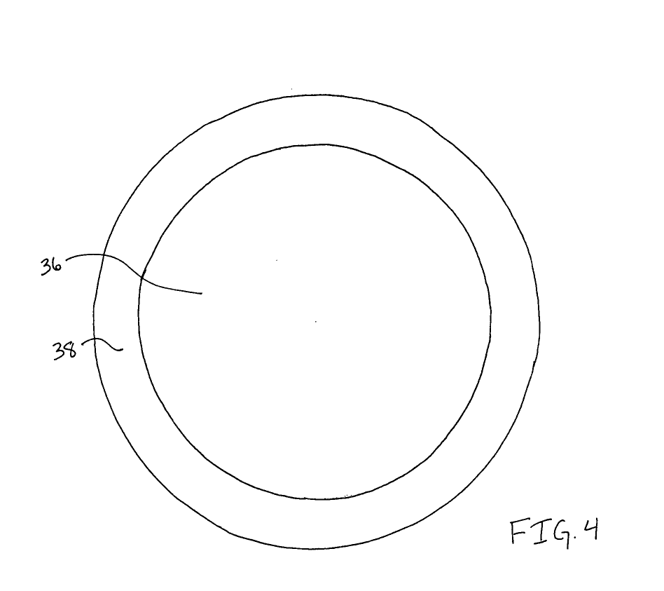

An exemplary light beam pattern for the present invention is shown in FIG. 2. The peripheral beam lamp 18, as described above with a substantially tapered cylindrical housing 20 and a condensing lens 30, forms a main beam 36 and a peripheral beam 38. The main beam 36 and the peripheral beam 38 converge at the focal point 40, and separate again, forming a cone shape further from the focal point 40. FIG. 4 shows the projected beam pattern along line A-A of FIG. 2. As shown in FIG. 4, a circular main beam 36 is projected from the peripheral beam lamp 18. Surrounding the circular main beam 36 is the peripheral beam 38. The light rays from the peripheral beam 38 strike the partially reflective section 24 inside the housing 20, and may be a different color than the light rays which comprise the main beam 36. Thus, the peripheral beam lamp 18 has a main beam 36 comprising light rays of a first overall color, and a peripheral beam 38 comprising light rays of a second overall color.

Although other advantages may be found and realized and various modifications may be suggested by those versed in the art, it is understood that the present invention is not to be limited to the details given above, but rather may be modified within the scope of the appended claims.

I claim:

1. A peripheral beam lamp comprising:
a. a housing, the housing having a sidewall with an inner surface, the inner surface having a non-reflective matte section and a partially reflective section; and
b. a condensing lens positioned in front of the housing.

2. A peripheral beam lamp as in claim 1, where the non-reflective matte section is adjacent to the partially reflective section.

3. A peripheral beam lamp as in claim 1, where the housing further comprises a first opening and a second opening, and where the partially reflective surface extends around the interior surface of the housing abutting the first opening, and the non-reflective matte section extends around the interior surface of the housing abutting the second opening.

4. A peripheral beam lamp as in claim 1, where the partially reflective surface is knurled.

5. A peripheral beam lamp as in claim 1, where the housing has a substantially conical shape.

6. A peripheral beam lamp as in claim 1, further comprising a light source positioned within the housing.

7. A peripheral beam lamp as in claim 6, where the light source is at least one light emitting diode.

8. A peripheral beam lamp as in claim 1, where the partially reflective section is a blue color.

9. A peripheral beam lamp comprising:
a. a housing, the housing having a sidewall with an inner surface, the inner surface having a non-reflective matte section and a partially reflective section, the housing further comprising a first opening and a second opening;
b. a condensing lens positioned in front of the second opening; and
c. a light source positioned within the housing.

10. A peripheral beam lamp as in claim 9, where the non-reflective matte section is adjacent to the partially reflective section.

11. A peripheral beam lamp as in claim 9, where the housing further comprises a first opening and a second opening, and where the partially reflective surface extends around the interior surface of the housing abutting the first opening, and the non-reflective matte section extends around the interior surface of the housing abutting the second opening.

12. A peripheral beam lamp as in claim 9, where the partially reflective surface is knurled.

13. A peripheral beam lamp as in claim 9, where the housing has a substantially conical shape.

14. A peripheral beam lamp as in claim 9, where the light source is at least one light emitting diode.

15. A peripheral beam lamp as in claim 9, where the partially reflective section is a blue color.

16. A method of providing a light beam for an automobile, comprising
a. providing a peripheral beam lamp, comprising:
i. a housing, the housing having an inner surface, the inner surface having a non-reflective matte section and a partially reflective section,
ii. a condensing lens positioned in front of the housing, and
iii. a light source positioned within the housing; and
b. energizing the light source, such that the light rays emitted from the light source and not striking the housing are emitted as a main beam, the light rays emitted from the light source and striking the non-reflective surface are substantially absorbed, and the light rays emitted from the light source and striking the partially reflective surface are reflected to form a peripheral beam.

17. A peripheral beam lamp comprising:
a. a housing, the housing having a sidewall with an inner surface, the inner surface having a partially reflective section; and
b. a condensing lens positioned in front of the housing.

18. A peripheral beam lamp as in claim 17, where the partially reflective surface is knurled.

19. A peripheral beam lamp as in claim 17, where the housing has a substantially conical shape.

20. A peripheral beam lamp as in claim 17, further comprising a light source positioned within the housing.

21. A peripheral beam lamp as in claim 18, where the light source is at least one light emitting diode.
